(19) United States
(12) Patent Application Publication
(10) Pub. No.: US 2026/0252194 A1
(43) Pub. Date: Aug. 27, 2026

(54) TOUCH DISPLAY SYSTEM WITH ACTIVE STYLUS AND CONTROL METHOD THEREFOR

(71) Applicant: NOVATEK MICROELECTRONICS CORP., Hsinchu (CN)

(72) Inventors: Wei-Kang Tsai, Hsinchu (CN); Po-Hao Kuo, Taoyuan (CN)

(21) Appl. No.: 19/455,339

(22) Filed: Jan. 21, 2026

Related U.S. Application Data
(60) Provisional application No. 63/762,643, filed on Feb. 25, 2025.

(30) Foreign Application Priority Data
Oct. 24, 2025 (CN) 202511532795.5

(51) Int. Cl. G06F 3/041

(52) U.S. Cl. CPC G06F 3/04184; G06F 3/04162; G06F 3/04166

(57) ABSTRACT

A control method for a touch display system with an active stylus and a touch display system are provided. In the control method, a display driver receives an active stylus synchronization signal from a touch controller, where the active stylus synchronization signal is generated by the touch controller based on a pen scanning period and a non-scanning period of the active stylus. The display driver determines, based on the received active stylus synchronization signal, an offset time of a display period of a current display frame relative to the non-scanning period, and delays based on the offset time, a display period of one or more subsequent display frames subsequent to the current display frame by a predetermined delay time with respect to a display period of a previous display frame thereof.

### CROSS REFERENCE TO RELATED APPLICATIONS

The present disclosure claims the benefit of U.S. Provisional Application No. 63/762,643 filed on Feb. 25, 2025 and Chinese Patent Application No. 202511532795.5 filed on Oct. 24, 2025, the contents of which are incorporated into the present disclosure by reference in its entirety.

### TECHNICAL FIELD

The present disclosure relates to a field of touch display technologies, and more particularly, to a control method for a touch display system with an active stylus and a touch display system.

### BACKGROUND

In a touch display system that adopts a time division operating mode, a frame is divided into a display period and a touch period that do not overlap with each other. When an active stylus is used for input operations on the screen, the display period often causes more noise interference to signals of the active stylus than the touch period, thereby adversely affecting the performance of the active stylus.

Typically, a touch controller in the system, after receiving a signal from an active stylus, may use an algorithm to synchronize with it. However, with a separate touch controller and display driver, the display driver cannot obtain the signal from the active stylus and therefore cannot synchronize with it. Therefore, there is a possibility that the signal input period of the active stylus and the display period overlap, causing display noise to affect the performance of the stylus.

Therefore, a technical solution that can effectively reduce the noise interference to the signals from the stylus during the display periods, thereby improving the performance of the stylus is needed.

### SUMMARY

Accordingly, the present disclosure provides a control method for a touch display system with an active stylus and a touch display system.

According to one aspect of the present disclosure, there is provided a control method for a touch display system with an active stylus, comprising: receiving, by a display driver, an active stylus synchronization signal from a touch controller, where the active stylus synchronization signal is generated by the touch controller based on a pen scanning period and a non-scanning period of the active stylus; determining, by the display driver based on the received active stylus synchronization signal, an offset time of a display period of a current display frame relative to the non-scanning period; and, delaying, by the display driver based on the offset time, a display period of one or more subsequent display frames subsequent to the current display frame by a predetermined delay time with respect to a display period of a previous display frame thereof.

According to another aspect of the present disclosure, there is provided a control method for a touch display system with an active stylus, comprising: receiving, by a display driver, an active stylus synchronization start command from a touch controller; starting, by the display driver in response to receiving the active stylus synchronization start command, to delay, on a frame-by-frame basis, a display period of one or more display frames with respect to a display period of a previous display frame thereof by a predetermined delay time; and, receiving, by the display driver, an active stylus synchronization end command from the touch controller, and ceasing to delay the display period of the display frames in response to the active stylus synchronization end command, where the active stylus synchronization start command and the active stylus synchronization end command are determined by the touch controller based on a signal-to-noise ratio of a signal received from the active stylus.

According to another aspect of the present disclosure, there is provided a touch display system, comprising: an active stylus; a touch display panel; a touch controller; and a display driver configured to perform the control method according to any one of the above.

In order to make the above features and advantages of the present disclosure more obvious and understandable, embodiments are listed below and described in detail with reference to the drawings.

### BRIEF DESCRIPTION OF THE DRAWINGS

The drawings are provided to provide a further understanding of the embodiments of the present disclosure, constitute a part of the specification, and serve to explain the present disclosure together with the embodiments of the present disclosure, but do not constitute limitations of the present disclosure. In the drawings, the same reference numeral generally represents the same part or step.

FIG. 1 shows a schematic diagram of a touch display system 100 with an active stylus in the prior art.

FIG. 2 shows an example of a display timing diagram according to an embodiment of the present disclosure.

FIG. 3 shows a control method 300 for a touch display system with an active stylus according to an embodiment of the present disclosure.

FIG. 4 shows an example of an active stylus synchronization signal 400 according to an embodiment of the present disclosure.

FIG. 5 shows an example of a timing control diagram for delaying the display period of a display frame according to an embodiment of the present disclosure.

FIG. 6 shows another control method 600 for a touch display system with an active stylus according to an embodiment of the present disclosure.

FIG. 7 shows another example of a timing control diagram for delaying the display period of a display frame according to an embodiment of the present disclosure.

FIG. 8 shows a signal noise time domain graph 800 of noise for signals of an active stylus sensed during a display period 801 and a touch period 802.

### DETAILED DESCRIPTION

In the following, the implementation of the present disclosure will be described in detail with the drawings and examples, to fully understand and implement the implementation process of the present disclosure to solve the technical problem and achieve the technical effect by using technical means. It should be noted that as long as there is no conflict, various embodiments in the present disclosure and various features in each embodiment can be combined with each other, and the formed technical scheme is within the protection scope of the present disclosure.

Meanwhile, in the following description, for explanation, numerous specific details are set forth to provide a thorough understanding of the embodiments of the present disclosure. However, it will be obvious to those skilled in the art that the present disclosure may be practiced without the specific details herein or the specific ways described.

An active stylus is an input tool that interacts with a touch display panel by transmitting signals. Through its built-in power supply and signal transmission device, it can actively send downlink signals to the touch display panel to achieve more precise and efficient touch operation. In addition to implementing basic touch functions, an active styluses can often use a built-in sensor to detect pen tip pressure, tilt angle, etc. exerted by the user, thereby generating corresponding pressure, tilt angle signals, etc. and transmitting them to the touch controller, to achieve more realistic writing effects.

FIG. 1 shows a schematic diagram of a touch display system 100 with an active stylus in the prior art. As shown in FIG. 1, the touch display system 100 may include a touch display panel 101, a display driver 102, a touch controller 103, and an active stylus 104. Among them, the display driver 102 can be used to drive pixels in the touch display panel 101 to achieve screen display, and the touch controller 103 can be used to detect and process the user’s touch operation through a finger or the active stylus 104 on the touch display panel 101, thereby realizing the touch function.

It should be noted that although the display driver 102 is shown as a single module in FIG. 1, it can be implemented through an integrated single-chip solution or a separate multi-chip solution, and the present disclosure does not limit this. For example, in one example, the display driver 102 may include a separate source driver, gate driver, and timing controller (TCON). In addition, a plurality of gate lines and a plurality of data lines for implementing the display function may be included between the display driver 102 and the touch display panel 101, and a plurality of touch lines for implementing the touch function may be included between the touch controller 103 and the touch display panel 101, which are not shown in FIG. 1 for simplicity.

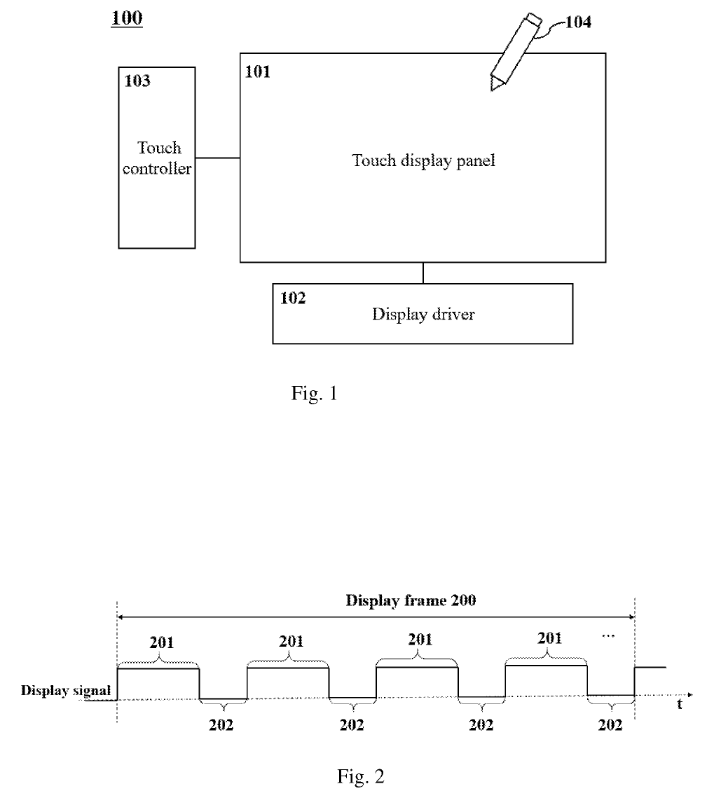

FIG. 2 shows an example of a display timing diagram according to an embodiment of the present disclosure. As shown in FIG. 2, a display frame 200 is divided into multiple display periods 201 and multiple touch periods 202 that do not overlap each other. The display driver (for example, the display driver 102 in FIG. 1) can output a display signal to a part of the data lines for display during one display period 201, then stop outputting the display signal in a subsequent touch period 202, and continue to output the display signal to another part of the data lines for display in the next display period 201, and so on. The touch period 202 may be used to implement scanning operations for signals from the active stylus, as described in detail below. It should be noted that although FIG. 2 shows that four display periods 201 and four touch periods 202 are included in one display frame 200, this is only an example, and the present disclosure does not limit the number of touch periods and display periods included in one display frame.

As mentioned previously, while the touch controller may use algorithms to synchronize with the signal from the active stylus after receiving it, with a separate touch controller and display driver architecture, the display driver may not obtain the signal from the active stylus to synchronize with it. Therefore, there is a possibility that the signal input period of the active stylus overlaps with the display period 201, thereby causing display noise to affect the performance of the stylus.

Therefore, in an embodiment of the present disclosure, after the touch controller receiving and synchronizes with the downlink signals from the active stylus, the touch controller may further send a signal or command for achieving synchronization to the display driver. The display driver may adjust display timing upon receipt of the signal or command, so as to achieve synchronization with the signal from the active stylus to avoid the impact of display noise on stylus performance.

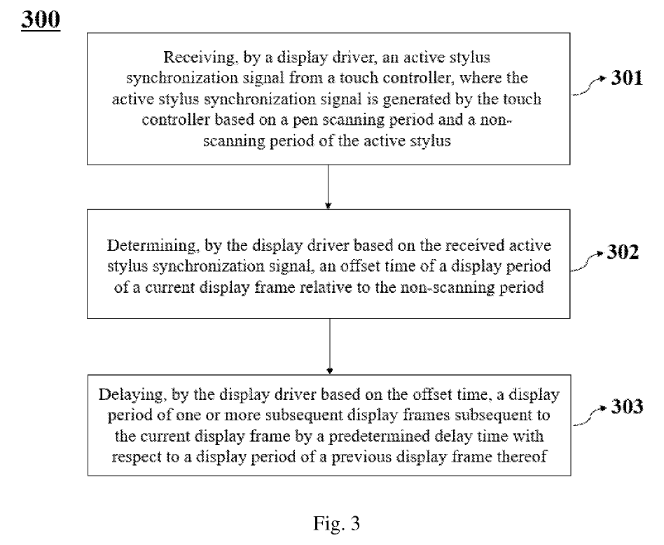

FIG. 3 shows a control method 300 for a touch display system with an active stylus according to an embodiment of the present disclosure.

As shown in FIG. 3, in step 301, a display driver receives an active stylus synchronization signal from a touch controller, where the active stylus synchronization signal is generated by the touch controller based on a pen scanning period and a non-scanning period of the active stylus. The display driver and touch controller in this step may be, for example, the display driver 102 and the touch controller 103 in FIG. 1 respectively, and transmitting the active stylus synchronization signal from the touch controller 103 to the display driver 102 may be achieved by adding a corresponding hardware pin to the display driver 102 and the touch controller 103.

In this step, the pen scanning period of the active stylus may be a periodic scanning period for scanning downlink signals from the active stylus for reception and processing, and there is a non-scanning period, in which downlink signals of the active stylus are not scanned, between two adjacent pen scanning periods. As previously described, the touch controller, after receiving the signal of the active stylus input, can synchronize with it using an algorithm to align the pen scanning period with the signal input period of the active stylus. In one example, the touch controller may achieve signal synchronization with the active stylus by receiving a beacon signal from the active stylus, where the beacon signal is an anchor signal that is periodically transmitted by the active stylus, upon which the touch controller may know the location of other signals following the beacon signal, such as a pressure signal, tilt angle signal, etc.

Normally, the frequency at which the active stylus sends downlink signals and the duration of the downlink signals can be predetermined according to specifications. Therefore, the duration of the pen scanning period and the non-scanning period can also be predetermined and pre-stored in the touch controller. In an embodiment according to the present disclosure, the durations of the display period and the touch period (for example, the display period 201 and the touch period 202 shown in FIG. 2) in the display frame may be set to be the same as the durations of the non-scanning period and the pen scanning period, respectively. In a subsequent step, the display driver may adjust the display timing based on the received active stylus synchronization signal to align display periods in the display frames with non-scanning periods of the active stylus, and to align touch periods in the display frames with pen scanning periods of the active stylus, so as to avoid the interference of the display signals applied in the display periods to the signals from the active stylus.

In step 302, the display driver determines, based on the received active stylus synchronization signal, an offset time of a display period of a current display frame relative to the non-scanning period.

In this step, after receiving the active stylus synchronization signal, the display driver may determine a start time of the non-scanning period of the active stylus based on the active stylus synchronization signal, and compare it with a start time of the display period of the current display frame to determine, based on a time difference between the two start times, the offset time of the display period of the current display frame relative to the non-scanning period.

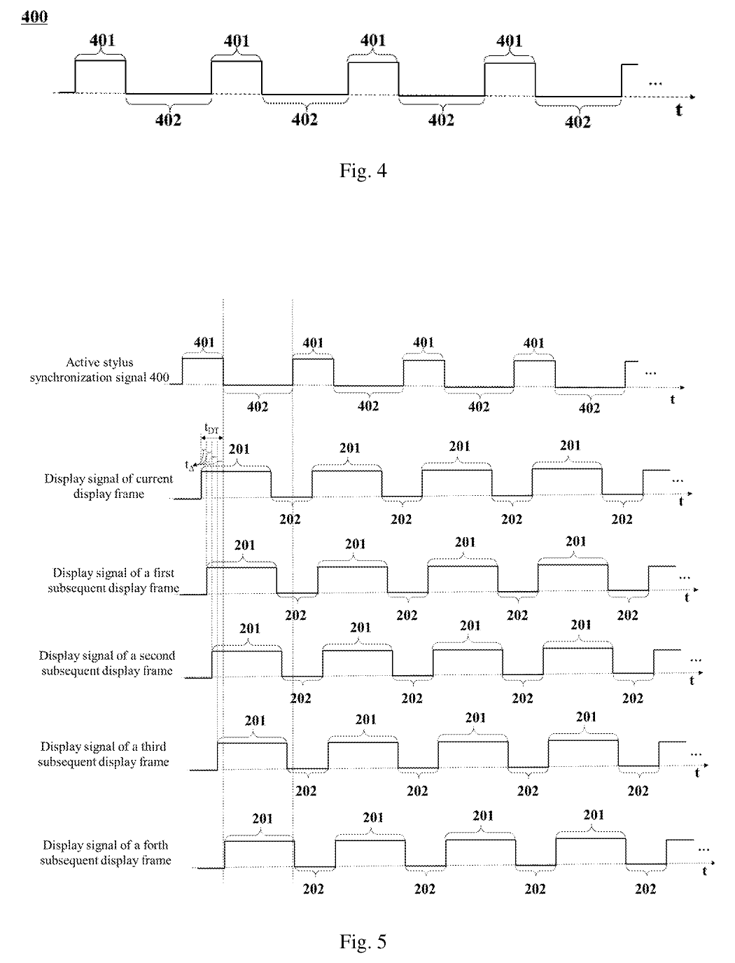

In one example, the active stylus synchronization signal may be a periodic signal having a first period corresponding to the pen scanning period and a second period corresponding to the non-scanning period, and the active stylus synchronization signal has a first level during the first period and a second level during the second period. FIG. 4 shows an example of an active stylus synchronization signal 400 according to an embodiment of the present disclosure. As shown in FIG. 4, an active stylus synchronization signal 400 has a first period 401 corresponding to a pen scanning period and a second period 402 corresponding to a non-scanning period, with a first level that is a high level during first period 401 and a second level that is a low level during second period 402. It should be noted that the form of the active stylus synchronization signal in FIG. 4 is only an example. According to embodiments of the present disclosure, other forms of active stylus synchronization signals can also be used, as long as the active stylus synchronization signal can reflect the pen scanning period and non-scanning period of the active stylus, which are not limited here.

In step 303, the display driver delays, based on the offset time, a display period of one or more subsequent display frames subsequent to the current display frame by a predetermined delay time with respect to a display period of a previous display frame thereof.

In this step, the display driver may delay the display period of one or more subsequent display frames by temporarily buffering the display data in a buffer without outputting it to the data lines.

FIG. 5 shows an example of a timing control diagram for delaying the display period of a display frame according to an embodiment of the present disclosure. The specific forms of the active stylus synchronization signal and the display signal as well as the reference numerals of each period in FIG. 5 are consistent with those shown in FIGS. 2 and 4.

As shown in FIG. 5, after receiving the active stylus synchronization signal 400, the display driver can determine the time difference t_{DT}between the start time of the display period 201 of the current display frame and the start time of the second period 402 (corresponding to the non-scanning period) of the active stylus synchronization signal 400, so that the time difference t_{DT} is used as the offset time of the display period of the current display frame relative to the non-scanning period. Subsequently, by delaying the display period of one or more subsequent display frames subsequent to the current display frame on a frame-by-frame basis, the display driver may delay the display period of each subsequent display frame with respect to the display period of a previous display frame thereof by a predetermined delay time t_{Δ}, so as to gradually reduce the offset time of the display period relative to the non-scanning period, until the display period 201 is aligned with the second period 402. As such, in the embodiment according to the present disclosure, signal synchronization with the active stylus can be achieved by gradually adjusting the display period of the display frame, which can avoid impact on the picture quality during the entire synchronization process, thereby ensuring a high quality of display pictures while preventing the display signals from interfering with the signals of the active stylus.

In one example, the display driver may compare the offset time of the display period of the current display frame relative to the non-scanning period with a preset first threshold, and, for example, only if the offset time is greater than the first threshold, the display driver may start the operation of delaying the display period of one or more subsequent display frames. If the offset time is not greater than the first threshold, the display driver may not delay the display period of one or more subsequent display frames, because the display period may already be approximately aligned with the non-scanning period at this time.

Additionally, the display driver may determine the number of the one or more subsequent display frames to be delayed based on a ratio of the offset time to the predetermined delay time. For example, continuing to refer to FIG. 5, the display driver may determine that the number of one or more subsequent display frames to delay is four by determining that the ratio of the offset time t_{DT}to the predetermined delay time t_{Δ} is equal to or is approximately four. It should be noted that the alignment of the display period with the non-scanning period by delaying 4 subsequent display frames as shown in FIG. 5 is only an example, and the display driver can delay other numbers of the subsequent display frames based on the actual offset time and the predetermined delay time to achieve alignment of the display period with the non-scanning period. In addition, those skilled in the art can appropriately set the first threshold and the predetermined delay time according to specific needs, and store them in the display driver in advance.

Typically, when an active stylus operates in different modes, the width of the downstream signals it sends may be different. For example, more signals are transmitted when the active stylus is in writing mode than in hovering mode in which the active stylus has not yet contacted the screen surface. In an embodiment, after the touch controller receives downlink signals from the active stylus, it may parse the downlink signals to determine which operating mode the active stylus is currently in, so as to determine different durations of the pen scanning periods and non-scanning periods for different operating modes, and to generate corresponding active stylus synchronization signals. Accordingly, after the display driver receives the active stylus synchronization signal, it may determine the duration of the non-scanning period based on the active stylus synchronization signal, thereby further setting the duration of the display period to be equal to the duration of the non-scanning period, and setting the duration of the touch period to be equal to the duration of the scanning period correspondingly. As such, only necessary scanning time may be reserved for the active stylus, and other time can be used for display operations, so as to further improve the display quality of pictures while reducing interference of the display signals to the signals of the active stylus.

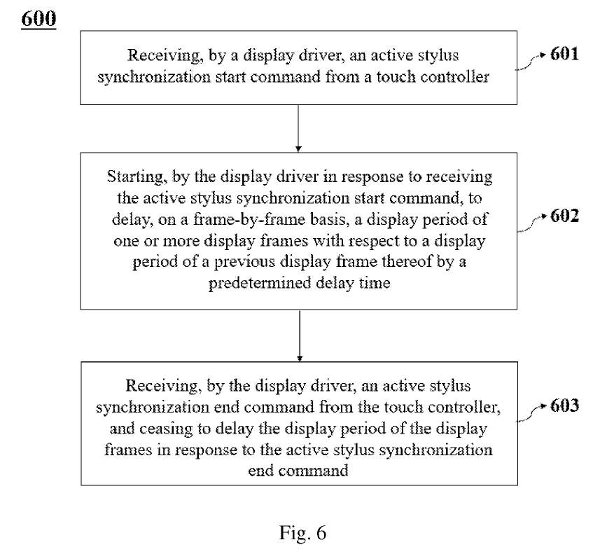

FIG. 6 shows another control method 600 for a touch display system with an active stylus according to an embodiment of the present disclosure. Being different from the control method 300 shown in FIG. 3, in the control method 600 of FIG. 6, it is the touch controller who decides when to start and end the delay adjustment of the display period of the display frame based on a signal-to-noise ratio of a signal from the active stylus, and sends corresponding start and end commands to the display driver.

Specifically, as shown in FIG. 6, in step 601, a display driver receives an active stylus synchronization start command from a touch controller. The display driver and the touch controller in this step may be, for example, the display driver 102 and the touch controller 103 in FIG. 1 respectively, and the transmission of the active stylus synchronization start command from the touch controller 103 to the display driver 102 may be implemented through corresponding registers.

In this step, the touch controller may determine, based on the signal received from the active stylus, a signal-to-noise ratio of the signal of the active stylus. Upon determining that the signal-to-noise ratio of the signal of the active stylus is below a second threshold, the touch controller may generate and send the active stylus synchronization start command to the display driver. Likewise, those skilled in the art can reasonably set the value of the second threshold according to specific needs and through offline experiments.

In step 602, the display driver may start, in response to receiving the active stylus synchronization start command, to delay, on a frame-by-frame basis, a display period of one or more display frames with respect to a display period of a previous display frame thereof by a predetermined delay time.

In this step, similarly, the display driver may delay the display period of the one or more display frames by temporarily buffering the display data in a buffer without outputting it to the data lines.

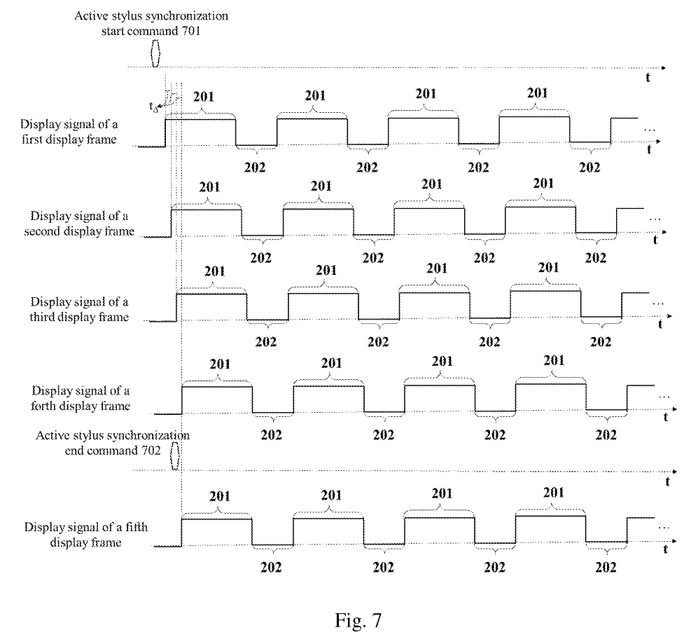

FIG. 7 shows another example of a timing control diagram for delaying the display period of a display frame according to an embodiment of the present disclosure. As shown in FIG. 7, after receiving an active stylus synchronization start command 701, the display driver may start to delay, on a frame-by-frame basis, the display period of one or more display frames with respect to the display period of a previous display frame thereof by a predetermined delay time. Specifically, the display driver may start to delay the display period 201 of a second display frame by a predetermined delay time t_{Δ} with respect to the display period 201 of the previous first display frame, delay the display period 201 of a third display frame by a predetermined delay time t_{Δ} with respect to the display period 201 of the previous second display frame, and so on. Similarly, those skilled in the art can appropriately set the predetermined delay time according to specific needs and store it in the display driver in advance.

In this step, the touch controller may synchronously measure and compare the signal-to-noise ratios of the signals of the active stylus before and after the delaying operation, thereby determining when to generate and send the active stylus synchronization end command to the display driver.

In step 603, the display driver receives an active stylus synchronization end command from the touch controller, and ceases to delay the display period of the display frames in response to the active stylus synchronization end command.

In one example, the touch controller may, upon determining that the signal-to-noise ratio of the signal received from the active stylus is above a third threshold, generate and send an active stylus synchronization end command to the display driver. The third threshold may be determined based on the optimal signal-to-noise ratio measured in advance through offline experiments. For example, the third threshold may be 90% of the measured optimal signal-to-noise ratio.

Continuing with FIG. 7, upon receiving the active stylus synchronization end command 702, the display driver may cease to delay the display period 201 of the display frames, so the display period 201 of a fifth display frame and subsequent display frames are aligned with the display period 201 of the fourth display frame.

In one example, the active stylus synchronization start command and the active stylus synchronization end command may be represented in a form of coded bits. For example, when two bits are used, 01 and 11 may be used to represent the active stylus synchronization start command and the active stylus synchronization end command, respectively. However, this is merely an example, and the present disclosure does not limit to it.

As previously described, after the touch controller receives downlink signals from the active stylus, it may parse the downlink signals to determine which operating mode the active stylus is currently in, so as to determine different durations of pen scanning periods and non-scanning periods for different operating modes. Accordingly, in one example, the active stylus may generate and send a corresponding display period setting command to the display driver based on the determined duration of the non-scanning period, so as to set the duration of the display period of the display frame equal to the determined duration of the non-scanning period. In this example, transmission of the display period setting command may be implemented with more bits, and different display period preset values corresponding to different display period setting commands may be stored in the display driver in advance. As such, only necessary scanning time may be reserved for the active stylus, and other time can be used for display operations, so as to further improve the display quality of pictures while reducing interference of the display signals to the signals of the active stylus.

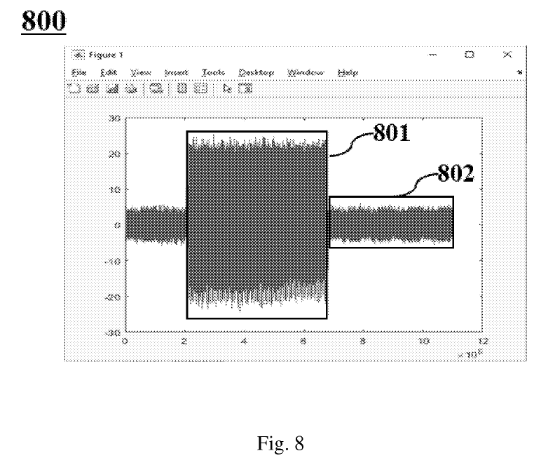

FIG. 8 shows a signal noise time domain graph 800 of noise for signals of an active stylus sensed during a display period 801 and a touch period 802. As shown, the display period 801 will contribute more noise to the signals of the active stylus compared to the touch period 802. It can be seen that by adjusting the display period of the display frame to implement the pen scanning operation during the touch period 802, compared with performing the pen scanning operation during the display period 801, the signal-to-noise ratio of the signals of the active stylus can be significantly improved, thereby improving the performance of the active stylus.

In summary, in the methods according to embodiments of the present disclosure, after the touch controller achieves synchronization with the signals from the active stylus, the touch controller can further send the signal or command for achieving synchronization to the display driver, so that the display driver can adjust the display timing after receiving the signal or command to achieve synchronization with the signals from the active stylus, thereby avoiding the impact of display noise on the stylus performance. In addition, by gradually adjusting the display period of the display frames to achieve signal synchronization with the active stylus, an impact on the picture quality can be avoided during the entire synchronization process, thereby ensuring a high quality of display pictures while preventing the display signals from interfering with the signals of the active stylus.

Below, a touch display system according to an embodiment of the present disclosure is described, including: an active stylus, a touch display panel, a touch controller, and a display driver that may be configured to perform various steps of the method described above. The touch display system and various components included therein may be as described above with respect to FIG. 1 and will not be described again here.

The basic principles of the present disclosure have been described above in connection with specific embodiments. It should be pointed out that the advantages, advantages, effects, etc. mentioned in the embodiments of the present disclosure are only examples rather than limitations, and these advantages, advantages, effects, etc. cannot be considered as necessary for all embodiments of the present disclosure. In addition, the specific details disclosed above are only for the purpose of illustration and easy understanding, but not for limitation, and the above details do not mean that the present disclosure must be realized with the above specific details. It should also be pointed out that in the device and method of the present disclosure, each component or step can be decomposed and/or recombined. These decompositions and/or recombination should be regarded as equivalent schemes of the present disclosure.

For ordinary operators in the field, it can be understood that all or any part of the method and device disclosed in the present disclosure can be implemented in hardware, firmware, software or their combination in any computing device (including processor, storage medium, etc.) or network of computing devices. The hardware may be a general-purpose processor, a digital signal processor (DSP), an application-specific integrated circuit (ASIC), a field programmable gate array signal (FPGA) or other programmable logic device (PLD), discrete gate or transistor logic, discrete hardware components, or any combination thereof designed to perform the functions described herein. A general-purpose processor may be a microprocessor, but alternatively, the processor may be any commercially available processor, controller, microcontroller or state machine. A processor may also be implemented as a combination of computing devices, such as a combination of a DSP and a microprocessor, a plurality of microprocessors, one or more microprocessors cooperating with a DSP core, or any other such configuration. Software can exist in any form of computer-readable tangible storage media. By way of example and not limitation, such computer-readable tangible storage media may include RAM, ROM, EEPROM, CD-ROM or other optical disk storage, magnetic disk storage or other magnetic storage devices or any other tangible media that can be used to carry or store desired program codes in the form of instructions or data structures and that can be accessed by a computer. As used herein, a disc includes a compact disc (CD), a laser disc, an optical disc, a digital versatile disc (DVD), a floppy disc and a Blu-ray disc.

The block diagrams of elements, components, equipment, devices and systems involved in the embodiments of the present disclosure are only illustrative examples and are not intended to require or imply that they must be connected, arranged and configured in the manner shown in the block diagram. As those skilled in the art will recognize, these elements, components, devices, devices and systems can be connected, arranged and configured in any way.

In addition, the claimed scope of the present disclosure is not limited to the specific aspects of the above-mentioned processing, machinery, manufacturing, composition, means, methods and actions of events. Components, means, methods or actions of processes, machines, manufacturing, and events that currently exist or are to be developed later can be utilized to perform basically the same functions or achieve basically the same results as those described herein.

In addition, words such as "including", "containing", "having" and so on are open words, which mean "including but not limited to" and can be used interchangeably with them. The terms "or" and "and" as used herein refer to the terms "and/or" and can be used interchangeably with them unless the context clearly indicates otherwise. The word "such as" used here refers to the phrase "such as but not limited to" and can be used interchangeably with it.

The above description of the disclosed aspects is provided to enable any operator in the art to make or use the present disclosure. Various modifications to these aspects will be obvious to those skilled in the art, and the general principles defined herein can be applied to other aspects without departing from the scope of the present disclosure. Therefore, the present disclosure is not intended to be limited to the aspects shown herein, but is to be accorded the widest scope consistent with the principles and novel features disclosed herein.

1. A control method for a touch display system with an active stylus, comprising:
receiving, by a display driver, an active stylus synchronization signal from a touch controller, wherein the active stylus synchronization signal is generated by the touch controller based on a pen scanning period and a non-scanning period of the active stylus;
determining, by the display driver based on the received active stylus synchronization signal, an offset time of a display period of a current display frame relative to the non-scanning period; and,
delaying, by the display driver based on the offset time, a display period of one or more subsequent display frames subsequent to the current display frame by a predetermined delay time with respect to a display period of a previous display frame thereof.

2. The control method of claim 1, wherein determining, by the display driver based on the received active stylus synchronization signal, the offset time of the display period of the current display frame relative to the non-scanning period comprises:
determining, by the display driver, a start time of the non-scanning period of the active stylus based on the active stylus synchronization signal, and comparing it with a start time of the display period of the current display frame to determine the offset time.

3. The control method of claim 1, wherein the active stylus synchronization signal is a periodic signal having a first period corresponding to the pen scanning period and a second period corresponding to the non-scanning period, and the active stylus synchronization signal has a first level during the first period and a second level during the second period.

4. The control method of claim 1, wherein based on the offset time being greater than a first threshold, the display driver delays the display period of the one or more subsequent display frames subsequent to the current display frame by the predetermined delay time with respect to the display period of the previous display frame thereof.

5. The control method of claim 1, wherein the number of the one or more subsequent display frames to be delayed is determined by the display driver based on a ratio of the offset time to the predetermined delay time.

6. The control method of claim 1, wherein durations of the pen scanning period and the non-scanning period are determined by the touch controller by parsing downstream signals from the active stylus, and the method further comprises:
determining, by the display driver, a duration of the non-scanning period based on the active stylus synchronization signal; and,
determining, by the display driver, a duration of the display period based on a duration of the non-scanning period.

7. A control method for a touch display system with an active stylus, comprising:
receiving, by a display driver, an active stylus synchronization start command from a touch controller;
starting, by the display driver in response to receiving the active stylus synchronization start command, to delay, on a frame-by-frame basis, a display period of one or more display frames with respect to a display period of a previous display frame thereof by a predetermined delay time; and,
receiving, by the display driver, an active stylus synchronization end command from the touch controller, and ceasing to delay the display period of the display frames in response to the active stylus synchronization end command,
wherein the active stylus synchronization start command and the active stylus synchronization end command are determined by the touch controller based on a signal-to-noise ratio of a signal received from the active stylus.

8. The control method of claim 7, wherein the active stylus synchronization start command is generated and sent to the display driver by the touch controller based on the signal-to-noise ratio of the signal received from the active stylus being below a second threshold.

9. The control method of claim 7, wherein the active stylus synchronization end command is generated and sent to the display driver by the touch controller based on the signal-to-noise ratio of the signal received from the active stylus being above a third threshold.

10. The control method of claim 7, wherein the method further comprises:
receiving, by the display driver, a display period setting command from a touch controller to control a duration of a display period of a display frame, wherein the display period setting command is generated by the touch controller by parsing a downstream signal from the active stylus.

11. A touch display system, comprising:
an active stylus;
a touch display panel;
a touch controller; and,
a display driver, configured to perform the method of claim 1.

12. A touch display system, comprising:
an active stylus;
a touch display panel;
a touch controller; and,
a display driver, configured to perform the method of claim 7.
